(19) United States
(12) Patent Application Publication
(10) Pub. No.: US 2026/0170343 A1
(43) Pub. Date: Jun. 18, 2026

(54) ANOMALY DETECTION FOR UNLABELED DATA BASED ON CONTRASTIVE LEARNING

(71) Applicant: STATE STREET BANK AND TRUST COMPANY, BOSTON, MA (US)

(72) Inventors: Yang Liu, Hangzhou (CN); Dajun Wang, Irvine, CA (US)

(21) Appl. No.: 18/978,195

(22) Filed: Dec. 12, 2024

(51) Int. Cl. G06N 3/088

(52) U.S. Cl. CPC G06N 3/088

(57) ABSTRACT

Exemplary embodiments may employ contrastive learning to identify anomalies in unlabeled data, such as tabular financial-related data. The contrastive learning may be performed by a neural network model. The exemplary embodiments may employ a hybrid approach that includes both a supervised component and an unsupervised approach. This enables the use of both supervised and unsupervised techniques to enjoy the expertise of the supervised technique while benefiting from an unsupervised technique. There is not the problem of the computational challenge of calculating probabilities for all locations as found in some conventional approaches.

### BACKGROUND

Conventional unsupervised approaches to identify anomalies in unlabeled data include those that use an autoencoder. An autoencoder is a type of neural network that learns an encoding function for transforming input data into an encoded representation and a decoding function that reconstructs the input data from the encoded representation of the data. The autoencoder is trained on unlabeled data that does not contain anomalies or contains a small amount of anomalies. When the data contains an anomaly, the autoencoder will have high reconstruction loss for anomaly (i.e., the decoded representation differs substantially enough from the input data to be deemed anomalous). Hence, the autoencoder may identify some anomalies.

There are several drawbacks to this approach of using an unsupervised autoencoder. First, the size of the latent space (i.e., encoded space) used is important but is difficult to determine. Second, if categorical data included, the method needs to predict the probabilities of all possible values for one location in the latent space, and the computational complexity increases exponentially with the number of possible values. Third, expert knowledge is not exploited to improve model performance. Fourth, such an unsupervised approach makes it difficult to ensure high performance.

### SUMMARY

In accordance with an inventive facet, a method is performed by a computing environment. The method includes ingesting unlabeled tabular data into the computing environment and analyzing the unlabeled tabular data with a contrastive learning module in the computing environment to identify a possible anomaly in the tabular data. The method further includes outputting information on a display device to identify the possible anomaly in the tabular data.

The method may provide a user interface for a user to indicate that the possible anomaly is an anomaly or not. The method may include storing in a storage an indication that the possible anomaly is an anomaly received via the user interface. The method may include training the contrastive learning module to identify possible anomalies and using the stored indication in the training. The training may include providing the contrastive learning module with an anchor, positive samples, and negative samples. The contrastive learning module may be a neural network model. The unlabeled tabular data may include financial data.

In accordance with another inventive facet, a non-transitory computer-readable storage medium may store programming instructions that when executed on one or more processors cause the one or more processors to ingest unlabeled tabular data into the computing environment and analyze the unlabeled tabular data with a contrastive learning module in the computing environment to identify a possible anomaly in the tabular data. The programming instructions when executed also may cause the one or more processors to output information on a display device to identify the possible anomaly in the tabular data.

The programming instructions when executed may further cause the one or more processors to provide a user interface for a user to indicate that the possible anomaly is an anomaly or not. The programming instructions when executed further may cause the one or more processors to store in a storage an indication that the possible anomaly is an anomaly received via the user interface. The programming instructions when executed further may cause the one or more processors to train the contrastive learning module to identify possible anomalies and using the stored indication in the training. The programming instructions when executed further may cause the one or more processors to train the contrastive learning module to identify possible anomalies. The training may include providing the contrastive learning module with an anchor, positive samples, and negative samples. The contrastive learning module may be a neural network model. The unlabeled tabular data may include financial data.

### BRIEF DESCRIPTION OF THE DRAWINGS

FIG. 1 depicts a high level block diagram of anomaly detection processing of unlabeled tabular data that may be performed in exemplary embodiments.

FIG. 2 depicts a high level flowchart of illustrative steps that may be performed in exemplary embodiments in detecting anomalies.

FIG. 3 depicts a block diagram of a computing environment suitable for exemplary embodiments.

FIG. 4 depicts a block diagram of a distributed computing environment suitable for exemplary embodiments.

FIG. 5 depicts a flowchart of illustrative steps that may be performed by exemplary embodiments in conducting anomaly analysis.

FIG. 6 depicts processing flow among modules and components of exemplary embodiments.

FIG. 7 depicts a diagram illustrating the modifications of a sample via random replacement to generate negative samples in exemplary embodiments.

FIG. 8 the generation of additional samples by shifting positions of data items in exemplary embodiments.

FIG. 9 depicts an illustrative contrastive learning neural network suitable for exemplary embodiments.

FIG. 10 depicts an illustrative portion of an analyst user interface of an exemplary embodiment.

### DETAILED DESCRIPTION

Exemplary embodiments may employ contrastive learning to identify anomalies in unlabeled data, such as tabular financial-related data. The contrastive learning may be performed by a neural network model. The exemplary embodiments may employ a hybrid approach that includes both a supervised component and an unsupervised approach. This enables the use of both supervised and unsupervised techniques to enjoy the expertise of the supervised technique while benefiting from an unsupervised technique. There is not the problem of the computational challenge of calculating probabilities for all locations as found in the conventional approach described in the Background section.

The exemplary embodiments may be well-suited for processing tabular non-image data. For example, the exemplary embodiments may be well-suited for finding anomalies in financial-related tabular data that is unlabeled. Consider the example of data relating to securities. There may be a number of fields of data that provide information about a particular security. For example, a call option may have field that indicate the strike price, the data of the option, whether the option is a U.S. option, etc. These fields may be viewed as being held in tabular format, with each field constituting a column.

When such data is being ingested into a computing environment, it is frequently the case where there are anomalies in the data being ingested. The exemplary embodiments may locate these anomalies to be located and fixed or to otherwise be addressed.

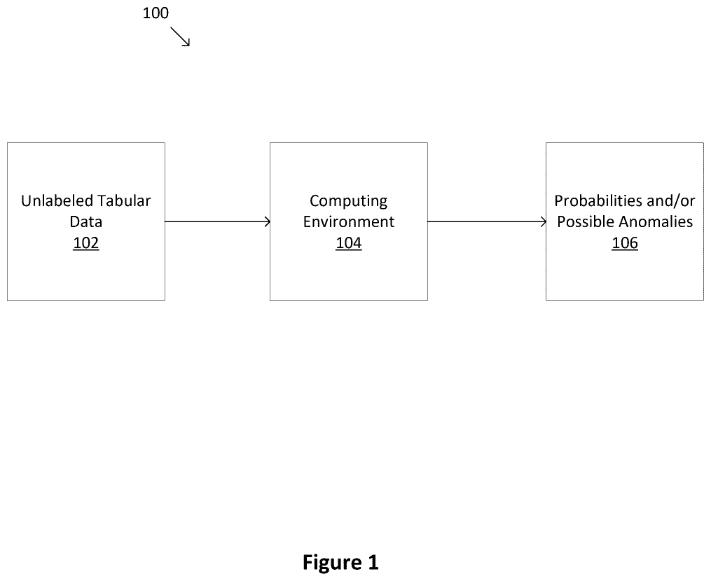

FIG. 1 depicts a high level diagram 100 depicting the processing flow that may be performed in exemplary embodiments. Initially, unlabeled tabular data 102 is ingested by a computing environment 104. The computing environment 104 performs processing on the unlabeled tabular data to identify possible anomalies as described in more detail below. The computing environment may output probabilities that possible anomalies are anomalies and/or may output the identity of the possible anomalies 106. In some instances, a user interface may be provided for an analyst to indicate whether the identified possible anomalies are anomalies or not.

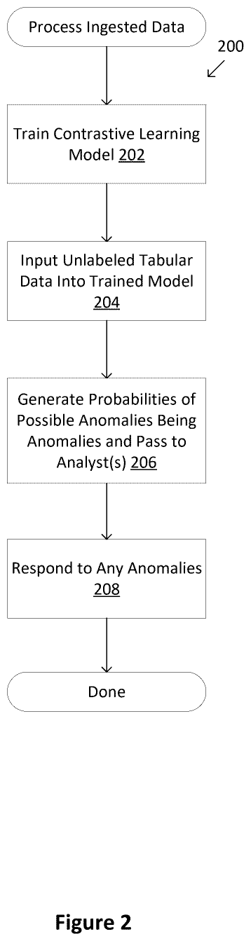

FIG. 2 depicts a high level flowchart 200 of illustrative steps that may be performed in exemplary embodiments to identify the possible anomalies and to respond to any identified anomalies. At 202, a contrastive learning model is trained. In contrastive learning, a data sample known as an anchor is selected. Also selected is a positive sample that is deemed to be like the anchor and a negative sample that is dislike the anchor. In contrastive learning models, samples are contrasted against each other, and those belonging to the same distribution are pushed towards each other in the embedding space. In contrast, those belonging to different distributions are pulled against each other. For example, suppose that the contrastive learning model is used for identifying whether an image is like the anchor or not. Further suppose that the image is of a dog. A positive sample is another image of a dog and a negative sample is an image of a cat. The contrastive learning model is trained by inputting unlabeled negative and positive samples and processing the samples with the model. The training seeks to adjust model parameters to minimize a loss function as discussed below.

Once the model is sufficiently trained, the model may be used to process data for anomalies. Hence, at 204, unlabeled tabular data is input into the trained model for processing. At 206, the trained model generates probabilities that possible anomalies are anomalies. Possible anomalies may be sent to analyst(s) for determining whether the possible anomalies are true anomalies or not. At 208, the system may respond to any anomalies, such as repairing the anomaly, disposing of the data, flagging the anomaly, etc.

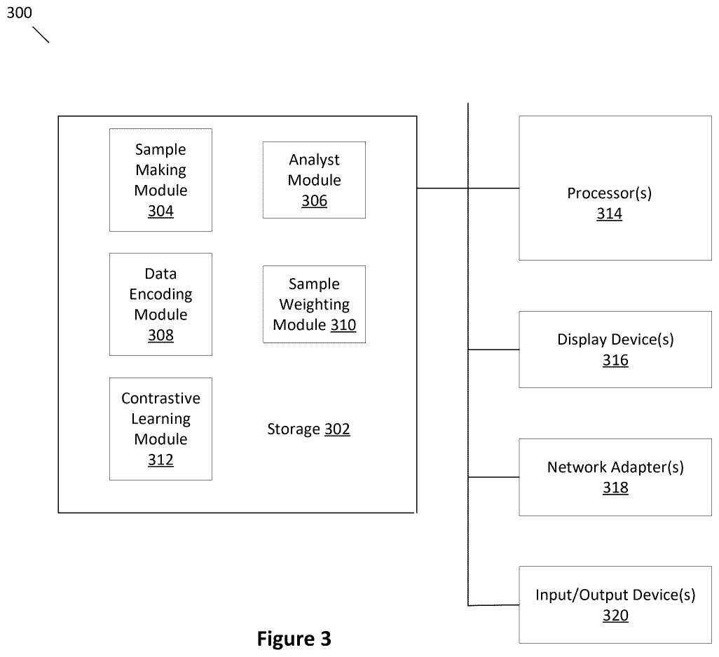

FIG. 3 depicts a block diagram 300 of a computing environment, such as a computing device, multiple computing devices (such as a cluster), or the like. The computing environment 300 may be resident wholly or partially on a network cloud. The computing environment 300 includes a storage 302 for storing items such as data, computer programming instructions, documents, web pages, or the like. The storage 300 may include one or more non-transitory computer-readable storage media. The storage 300 may include magnetic storage devices, optical storage devices, solid state storage devices, random access memory (RAM) devices, read only memory (ROM) devices, and combinations thereof. FIG. 3 depicts the storage holding computer programming instructions and data for a sample making module 304. The sample making module 304 generates samples from the raw data that are properly sized for processing by the contrastive learning model. The sample making module 304 may generate negative samples from a positive sample in the raw data as described below. The storage 302 may also store a data encoding module 308, which includes computer programming instructions that encode samples as vectors. The storage 302 may store the contrastive learning module 312, which may be realized as a neural network model as detailed below. The storage 302 may store an analyst module 306. The analyst module 306 may contain computer programming instructions that enable analysts to view possible anomalies, indicate whether the possible anomalies are true anomalies, and respond to anomalies, such as by flagging the anomaly, discarding the data that contains the anomaly, fixing the anomaly, or the like. The storage 302 also may store a sample weighting module 310 containing computer programming instructions for determining weights to be applied to samples in the learning process by the contrastive learning model.

The computing environment 300 may include one or more processors 314 for executing computer programming instructions, like those stored in the storage 302. The processor(s) 314 may include one or more of a central processing unit (CPU), a graphics processing unit (GPU), an application specific integrated circuit (ASIC), a field programmable gate array (FPGA), and/or other type of logic. The computing environment 300 may include one or more display devices 316. The computing environment 300 may include one or more network adapters 318 for interfacing with a network, such as the Internet, the World Wide Web, a local area network (LAN), a wide area network (WAN), or combinations thereof. The computing environment 300 may include one or more input or output devices 320, such as a keyboard, a mouse, a thumbpad, a microphone, a printer, a loudspeaker, etc.

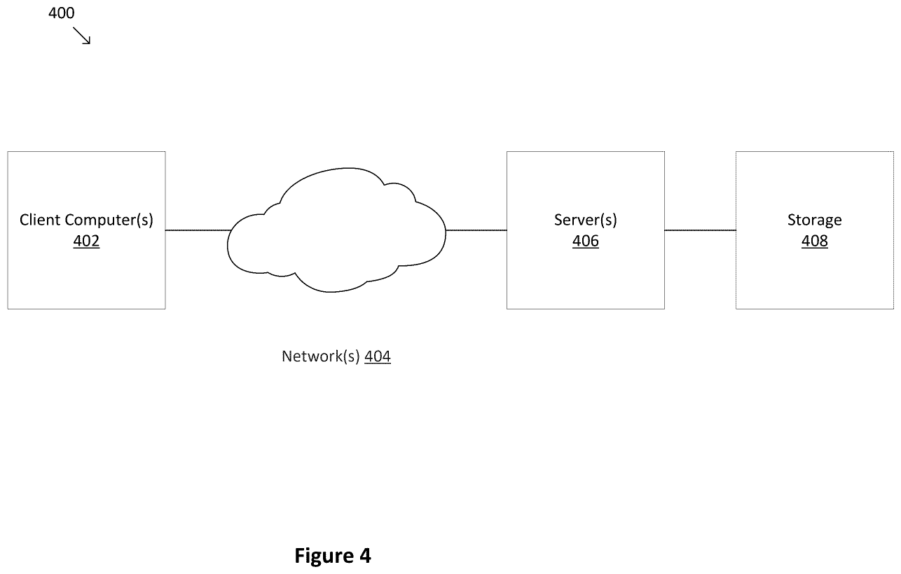

The computing environment 300 may be a distributed computing environment. FIG. 4 depicts a suitable illustrative computing environment 400. The distributed computing environment 400 may include client computer(s) 402 that gain access to server(s) 406 over network(s) 404. The server(s) 406 may have access to storage 408. The server(s) 406 and storage 408 may be like that described relative to FIG. 3. In some embodiments, analyst(s) may access web pages provided by server(s) 406 in processing possible anomalies. Raw data for processing may originate from a client computer 402 or from a server 406. At least some of the servers 406 may include the computer programming instructions and data that were described relative to FIG. 3.

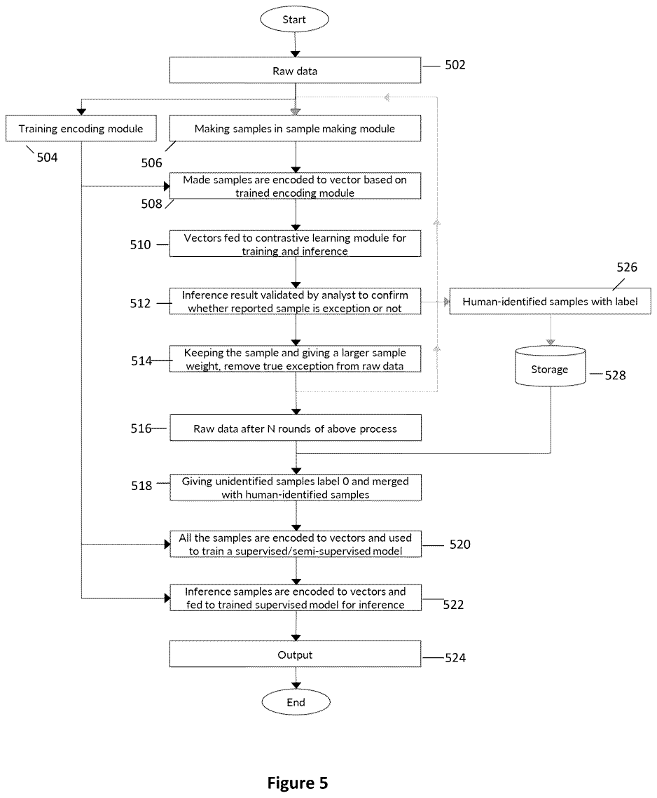

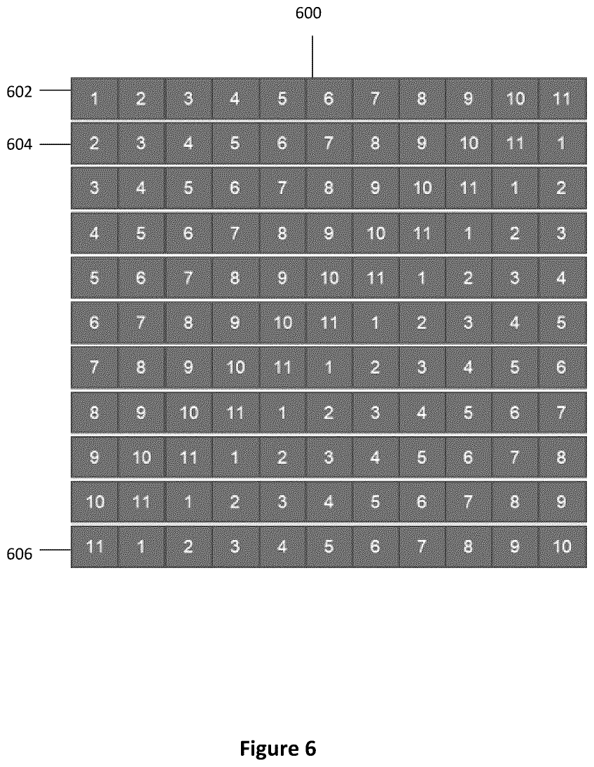

FIG. 5 depicts a flowchart 500 of illustrative steps that may be performed when the processor(s) 314 execute the modules 304, 306, 308, 310, and 310 in exemplary embodiments. Initially, at 502, the raw data 102 may be received by the computing environment 104. At 504, the raw data is used to train the data encoding module 308. The data may have a large vocabulary space and may have strong relations among the columns. An embedding tool, like Word2Vector, may be used by the data encoding module 308 to learn the relations among the columns and to encode data into vectors. Since Word2Vector focuses on centrally located words, some words in the first column and last columns of the sample may not be learned well. Hence, in exemplary embodiments the samples used for training may be constructed such that the first row 602 is presented in origin rank as shown in the sample block 600 of FIG. 6. Each subsequent row is shifted by one column. Thus, the second row 604 is shifted by one column, whereas the last row 606 is shifted by 10 columns. As a result, one sample of raw data may produce 11 samples with 11 columns as shown in FIG. 6.

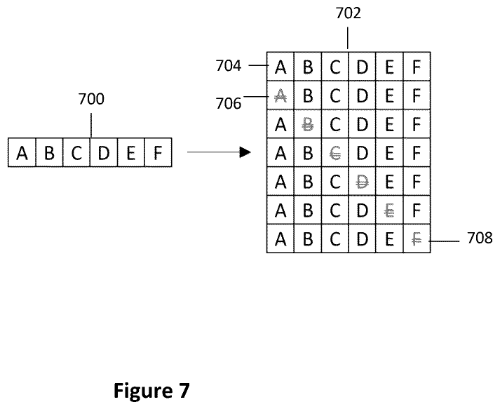

As the data encoding module is trained, at 506, the raw data is fed into the sample making module 304. The sample making module 304 makes samples from the raw unlabeled tabular data. FIG. 7 depicts an example of a transformation of raw data 700 and a sample block 702 generated by the sample making module 304. The first row 704 of the sample block 702 matches the raw data and serves as a positive sample. Data augmentation is performed by replacing data fields in the positive sample with random values to create negative samples, where the random values come from the same column but different samples. For instance, in row 706, the first field is replaced with a random value. Each successive row has a next data value position relaced with a random value until the last position is replaced with a random value in row 708. In this fashion, the sample block 702 is generated.

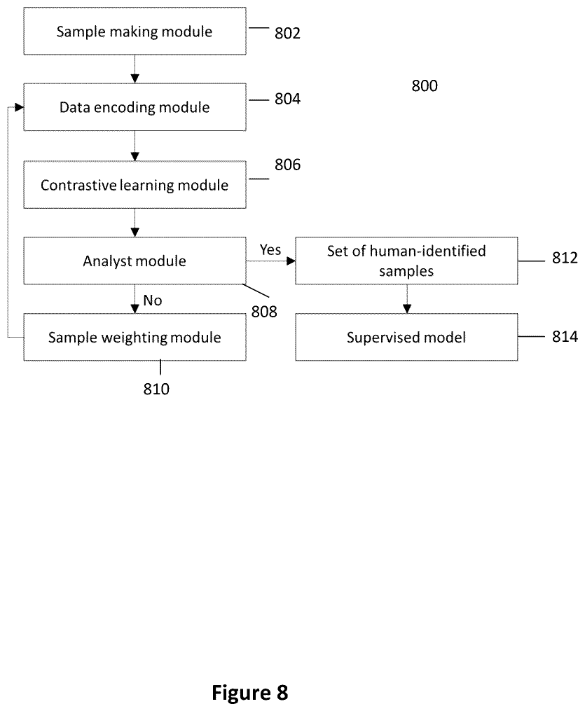

At 508, the samples are encoded by the trained data encoding module 308. The encoding transforms to samples into vectors. FIG. 8 shows a diagram 800 of the processing flow in exemplary embodiments. As shown, the sample make module 802 passes the samples to the data encoding module 804.

At 510, the vectors are fed into the contrastive learning module for training and inference. This also can be seen in the arrow leading from the data encoding module 804 to the contrastive learning module 806 in FIG. 8. The contrastive learning model determines the probability that a sample contains an anomaly. At 512, any possible anomalies may be sent to the analyst(s) for confirming any possible anomalies are true anomalies (“exceptions”). This is shown as output from the contrastive learning module 806 to the analyst module in FIG. 8. At 514, true exceptions as confirmed by the analyst(s) are removed from the training set, and those samples deemed not be exceptions are assigned greater weights (see sample weighting module 810). At 526, the analyst-labeled samples (812) are stored in storage 528 for use in training, There may be thousands of labeled data samples, which is sufficient to enough to train the model. After several iterations of steps 506-514, raw data is produced at 516.

At 518, the unlabeled data may be labeled, such as with a “0” and may be merged with samples confirmed by the analysts. At 520, these combined samples are used to train a model that may be supervised or semi-supervised. At 522, the samples to be input to the contrastive learning model are encoded by the data encoding module and fed to a supervised model (814). At 524, the supervised module produces the output.

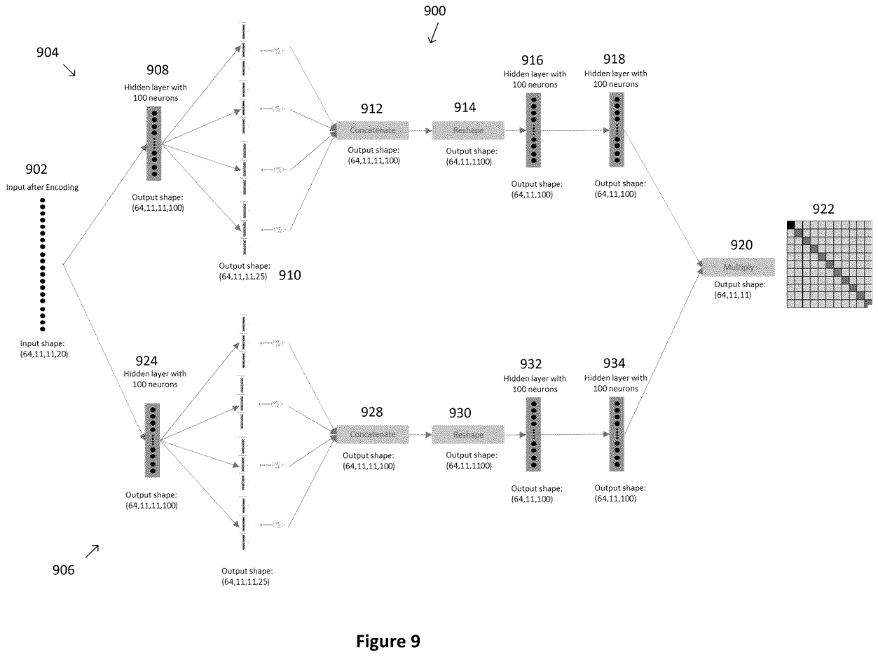

FIG. 9 depicts an illustrative contrastive learning model 900. The encoded input 902 is fed into the model 900 via an input layer. In this example, raw data is of a size (64,11) and that is fed into the sample making module 304 to produce an output that is (64,11,11). This output is fed to the data encoding module 308 so that the encoded data is (64,11,11,20). The model includes an upper portion 904 and a lower portion 906, that are identical. First layers 908 and 924 are hidden layers. In this example, each hidden layer 908 and 924 contains 100 neurons. The output from the hidden layers is (64,11,11,100). The outputs pass to multi-head self-attenuation layers 910 and 926. The self-attenuation layers learn the relations among vocabularies. Each self-attenuation layer 910 and 926 includes four small networks in this example. A concatenation layer 912 and 928 and concatenates the outputs from the small network that is sized as (64,11,11,100). A reshape layer 914 and 930, reshapes the output from the concatenation layer to be (64,11,1100). The reshaped output is passed to hidden layers 916 and 932 and then on to respective hidden layers 918 and 934. The outputs from these hidden layers are fed to a matrix multiplication layer that produces a (64,11,11) output 922.

A suitable loss function for the model is:

$$loss = - log \frac{z ( 0 , 0 )}{{\sum }_{i = 1}^{n} z ( 0 , i )} - log \frac{z ( 0 , 0 )}{{\sum }_{i = 1}^{n} z ( 0 , i )} + \frac{1}{n} {\sum }_{j = 1}^{n} \frac{z ( j , 0 )}{{\sum }_{i = 1}^{n} z ( j , i )}$$

where for n-th sample, the coordinate of (0,0) means the value in (n, 0, 0) of output 922, and the coordinate of (j, i) means the value in (n, j, i) of output 922. Value in (0,0) is the product between the first row of sample block 702 and itself. Value in (j, i) is the product between the j-th row and i-th row of sample block 702. The first and second items of equation right side means the product between positive sample and itself comparing to the product between positive sample and negative sample is the larger the better. For the third item, there is a constraint condition that product between positive and negative should be comparable to that between negative and negative.

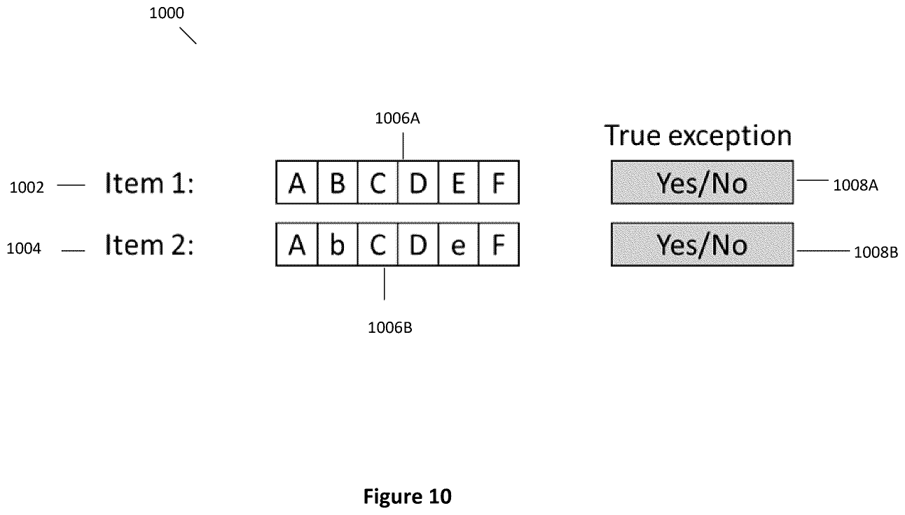

FIG. 10 depicts a portion of user interface 1000 that may be provided by the analyst module to analyst(s). The user interface 1000 may list items 1002 and 1004 that require analyst review. Each item, includes a listing of the data items 1006A and 1006B. The analyst may review the data items and determine if there is an anomaly. Via UI element 1008A and 1008B, the analyst may indicate if there is a true anomaly that constitutes an exception. Its should be appreciated that other varieties of user interfaces may be provided to display the data items under consideration and to enter analyst input.

While exemplary embodiments have been described herein, it should be appreciated that various changes in form and detail may be made without departing form the intended scope of the appended claims and equivalents thereof.

1. A method performed by a computing environment, comprising:
ingesting unlabeled tabular data into the computing environment;
analyzing the unlabeled tabular data with a contrastive learning module in the computing environment to identify a possible anomaly in the tabular data; and
outputting information on a display device to identify the possible anomaly in the tabular data.

2. The method of claim 1, further comprising providing a user interface for a user to indicate that the possible anomaly is an anomaly or not.

3. The method of claim 2, further comprising storing in a storage an indication that the possible anomaly is an anomaly received via the user interface.

4. The method of claim 3, further comprising training the contrastive learning module to identify possible anomalies and using the stored indication in the training.

5. The method of claim 4, further comprising training the contrastive learning module to identify possible anomalies.

6. The method of claim 5, wherein the training comprises providing the contrastive learning module with an anchor, positive samples, and negative samples.

7. The method of claim 6, wherein the contrastive learning module is a neural network model.

8. The method of claim 7, wherein the unlabeled tabular data is financial-related data.

9. A non-transitory computer-readable storage medium storing programming instructions that when executed on one or more processors cause the one or more processors to:
ingest unlabeled tabular data into the computing environment;
analyze the unlabeled tabular data with a contrastive learning module in the computing environment to identify a possible anomaly in the tabular data; and
output information on a display device to identify the possible anomaly in the tabular data.

10. The non-transitory computer-readable storage medium of claim 9, wherein the programming instructions when executed further cause the one or more processors to provide a user interface for a user to indicate that the possible anomaly is an anomaly or not.

11. The non-transitory computer-readable storage medium of claim 10, wherein the programming instructions when executed further cause the one or more processors to store in a storage an indication that the possible anomaly is an anomaly received via the user interface.

12. The non-transitory computer-readable storage medium of claim 11, wherein the programming instructions when executed further cause the one or more processors to train the contrastive learning module to identify possible anomalies and using the stored indication in the training.

13. The non-transitory computer-readable storage medium of claim 12, wherein the programming instructions when executed further cause the one or more processors to train the contrastive learning module to identify possible anomalies.

14. The non-transitory computer-readable storage medium of claim 13, wherein the training comprises providing the contrastive learning module with an anchor, positive samples, and negative samples.

15. The non-transitory computer-readable storage medium of claim 14, wherein the contrastive learning module is a neural network model.

16. The non-transitory computer-readable storage medium of claim 15, wherein the unlabeled tabular data is financial-related data.

17. A computing environment, comprising:
a storage for storing computer programming instructions;
one or more processors configured for executing the computer programming instructions to:
ingest unlabeled tabular data into the computing environment;
analyze the unlabeled tabular data with a contrastive learning module in the computing environment to identify a possible anomaly in the tabular data; and
output information on a display device to identify the possible anomaly in the tabular data.

18. The computing environment of claim 17, wherein the one or more processors are further configured to execute the computer programming instructions to train the contrastive learning module to identify possible anomalies.

19. The computing environment of claim 18, wherein the training comprises providing the contrastive learning module with an anchor, positive samples, and negative samples.

20. The computing environment of claim 19, wherein the unlabeled tabular data is financial-related data.
